(19) United States
(12) Patent Application Publication
(10) Pub. No.: US 2010/0329149 A1
(43) Pub. Date: Dec. 30, 2010

(54) UNIVERSAL CONNECTIONS DATA COLLECTION

(75) Inventors: Sumeet SINGH, Bangalore (IN); Clinton Donald ADAMS, Collegeville, PA (US)

Correspondence Address: Pepper Hamilton LLP, 400 Berywn Park, 899 Cassatt Road, Berwyn, PA, 19312-1183, US

(73) Assignee: FIBERLINK COMMUNICATIONS CORPORATION, Blue Bell, PA (US)

(21) Appl. No.: 12/826,319

(22) Filed: Jun. 29, 2010

Related U.S. Application Data
(60) Provisional application No. 61/221,375, filed on Jun. 29, 2009.

(51) Int. Cl. H04L 12/28

(52) U.S. Cl. 370/254

(57) ABSTRACT

Universal connection data collection solution for monitoring, collecting and reporting connection data and/or attributes for endpoint computing devices making a connection to a network for use in analyzing user behavior and device connectivity efficiencies. Embodiments include IP connections wherein the universal connections data collection module is notified by the OS of IP connection events. Embodiments may include a standalone mode of the universal connections data collection solution and add-on modes wherein the universal connections data collection solution integrates with a third party connection manager using an API to communicate. The universal connections data collection solution monitors the state of network connections by enumerating connections, comparing the list of active connections to the last known snapshot of the network state to determine a network state change (e.g., new connection, change in connection state, disconnection), and periodically updating the statics of the connected network. Network connection details may be exported in the form of connection logs.

### CROSS-REFERENCE TO RELATED APPLICATIONS

This application claims priority to U.S. provisional application Ser. No. 61/221,375 filed Jun. 29, 2009, which is incorporated herein by reference in its entirety.

### TECHNOLOGY FIELD

The present invention relates generally to the management of computer-based information systems, and more particularly to systems and methods that facilitates universal collection and reporting of connections data (e.g., Internet Protocol (IP) connections) for endpoint computing devices connected over a network.

### BACKGROUND

The industrialized world is becoming increasingly dependent on computing devices, such as computers and smart mobile devices, connected via a network. Advances in the global computing and telecommunication infrastructure have provided significant flexibility in corporate operations and in the way organizations view their workforce. For example, increasing numbers of employees work from remote locations (e.g., home, hotel, airport, etc.) by accessing corporate resources via a secure connection to their employer's computer network. Also, the number and types of communications mediums available for making a connection are also increasing and providing users with multiple means for connecting to a network. Corporations want to see what their employees are doing from a connection point of view.

Connection managers currently exist for facilitating the connection of computing devices to a network. Some of these connection managers provide a notification that a connection has been made and others may collect data related to the connections made by the connection manager. These conventional connection managers are located at the endpoint—i.e., any computing device that is somehow making a connection to the network. Some conventional connection managers do not collect any other data other than that a connection has been made and therefore do not provide any other useful data. Other conventional connection managers may collect other data, however, these connection managers do not have any visibility of connections made outside that particular connection manager.

As such, the collection of data related to connections (e.g., IP connections) and the user experience related to making connections (e.g., IP connections) is limited to the capabilities that are included in the connection manager being used and are dependant on the connection being made by that connection manager. Data collection can be limited in situations where the connection manager does not perform collection, robust collection, or the connection is made without a connection manager being used. What is needed is a universal connection data collector that can provide a mechanism to collect connection data in a consistent and reliable manner independent of any connection manager and in the event that a connection manager is not being used.

IT administrators desire access to data that can be used to understand user behavior and experience. Information derived from this data may be compelling and valuable to a company. A problem currently evolving is that the market is moving toward a user empowered selection of connection means leaving a reporting gap because, as discussed above, existing connection managers are not capable of reliably collecting connections data in all of these instances. The IT administrators, however, still want the connection data that show user behavior. What is needed is a mechanism to maintain and enhance the value provided in the collection and reporting of connection data even as users stop using conventional connection manager.

### SUMMARY

Embodiments of the present invention address and overcome one or more of the above shortcomings and drawbacks, by providing devices, systems, and methods for universal connections data collection for a computing device making a connection to a network. Embodiments of the present invention provide for universal connections data collection irrespective of the underlying connection manager(s). Embodiments of the present invention allow connections data to be collected regardless of the device or software used for connectivity across various dimensions. The Universal Connections Data Collection solution acts as a brain for all connections—by enumerating connections, monitoring connections statically, processing the collected connections data, and providing notification and reporting of connection data and attributes. This technology is particularly well-suited for, but by no means limited to, Internet Protocol (IP) connections data collection.

According to one embodiment of the invention, the IP connections data collector solution functions in a standalone mode. In an exemplary standalone embodiment, the Universal Connections Data Collection module may collect, process, store, and upload connections data (e.g., IP connection data) without any dependencies on other components.

According to one aspect of the invention, the Universal Connections Data Collection module may include an event notification module, a collector module to collect and initially store the data, a correlation module to process and normalize the collected data, and an upload module for uploading the normalized records. The Universal Connections Data Collection module may be installed on the endpoint and perform the job of collecting, processing (e.g., normalizing), storing and uploading to a central repository the network connections information.

According to an aspect of the invention, the notification module may include an agent event notification listener that may be triggered by network change events. Network change events may be generated, for example, as OS network change event and/or third party connection manager connectivity events. Received notifications may be compared to a set of configurable criteria. Notification information may be parsed for interesting notifications by looking at the adapter name where the notification was generated. A specific list of known adapters may be part of the Universal Connections Data Collection module. A connection event detected by the agent event notification listener may be passed to the networks inspection module and an initial parsing of the event notifications may be made to identify events of interest.

According to another aspect of the invention, the collector module may include a data formatting and collation module. Logic for determining a network state change may be used to compare connected networks with the last saved connected networks to determine whether the connection event is a new or lost connection. A scan of the adapter and OS attributes may be performed as part of the initial connection collection. Connection data collection may continue until a disconnect is noticed. When a notification is received for the same adapter indicating that it has experienced an IP state change or a disconnect, a final connection collection may be performed and a correlation triggered.

The correlation module may include the data format and collation module and associate logic to parse the collected connections data and create a collection record with the connections data and any attributes collected. The upload module may upload the collected connections data/attributes to a unified reporting solution. Collected connections data may be useful to help analyze user behavior and computing device connection usage for a group of computing devices.

In another embodiment of the invention, the IP connections data collector solution includes integration with a third party connection manager. In one exemplary add-on embodiment, the Universal Connections Data Collection module may integrate to other computing device software using an Application Programming Interface (API) to communicate. Examples of other computing device software would include third party connection managers that provide a mechanism to get connected and that collect data related to the connections that are made. In another embodiment of the invention, the IP connections data collector solution includes documented API integration with third party connection manager.

In certain embodiments, the Universal Connections Data Collection module may provide for monitoring and reporting of connections within connections. In certain embodiments, an endpoint computing device may have multiple network connections at the same time.

In some embodiments, the monitoring and collection of IP connections data occurs continuously and in real time. The OS notifies the Universal Connections Data Collection solution of a connection, disconnection, and/or change in state of an IP connection. Continuous monitoring and event driven OS notification allows the Universal Connections Data Collection solution to collect connections data without visibility of, for example, when someone hits a connect button.

Information collected and reported on may include various pieces of useful connections data that help to understand user behavior and existing connectivity efficiencies on the computing device. Uploading and reporting may occur periodically. The periodicity may be based on pre-determined time intervals and/or upon the detection of an event (e.g., connection, disconnection, change in state, etc.). The predetermine time intervals may be based on, for example, the particular application and the reporting needs.

Additional features and advantages of the invention will be made apparent from the following detailed description of illustrative embodiments that proceed with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an exemplary high level approach for the collection and reporting of IP connection data;

FIG. 2 is an exemplary screenshot illustrating a summary by device report;

FIG. 3 is an exemplary screenshot illustrating a connection details report;

FIG. 4 is an exemplary screenshot illustrating a Wi-Fi details report;

FIG. 5 is a block diagram of an exemplary embodiment of the IP connections data collector outlining the process flow for the collection module functioning in a standalone mode;

FIG. 6 is a logic flow diagram of the standalone mode of FIG. 5;

FIG. 7 is a block diagram of an exemplary embodiment of the IP connections data collector outlining the process flow for a collection module having API integration with a third party connection manager;

FIG. 8 is a logic flow diagram of the operating mode depicted in FIG. 7;

FIG. 9 is a block diagram of an exemplary embodiment of the IP connections data collector outlining the process flow for a collection module having document API integration with third party connection manager;

FIG. 10 is a logic flow diagram of the operating mode depicted in FIG. 9;

FIG. 11 is a logic flow diagram of exemplary collections logic that may be used with the various embodiments of the invention;

FIG. 12 is a logic flow diagram of exemplary correlation logic that may be used with the various embodiments of the invention; and

FIG. 13 is a block diagram of an example computing environment in which an example embodiment of the present invention may be implemented.

### DETAILED DESCRIPTION OF ILLUSTRATIVE EMBODIMENTS

The above problems and shortcomings in the prior art have motivated the creation of systems and methods to facilitate the collection of information for connections that are made by a computing device to a network. The present invention is directed to systems and methods that will facilitate the collection of all network connection information from a endpoint computing device and the delivery of the collected connections information to a central reporting solution for consumption and analysis by, for example, IT administrators.

The information collected and reported on may include various pieces of useful data that help to understand user behavior and existing connectivity efficiencies on the computing device. Some examples of useful data that may be collected and reported include, but are not limited to: the medium of connectivity used (e.g., Wi-Fi, Mobile data, Virtual Private Network, etc.); duration of each connection; causes for success or failure in connection attempts; duration of connection while on corporate network; state of endpoint during the connection; and the like.

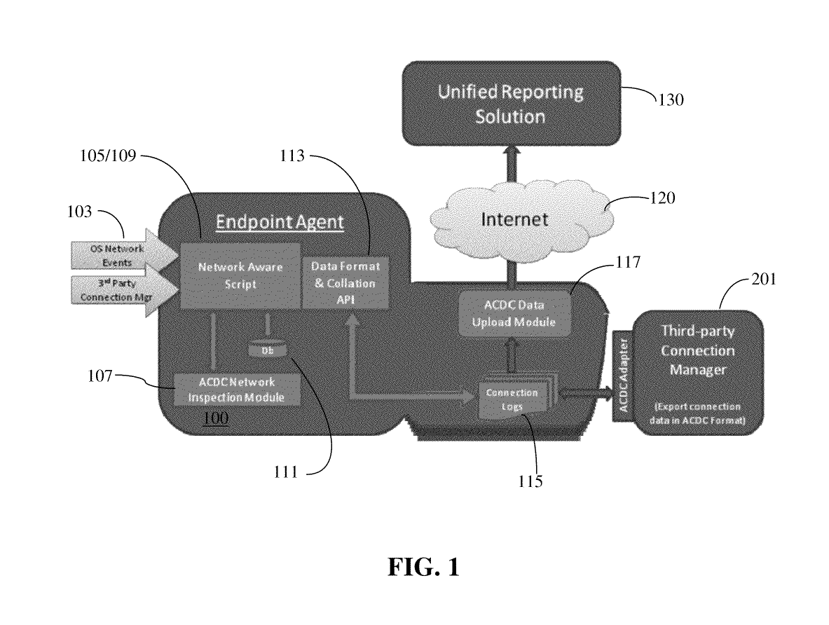

FIG. 1 shows an exemplary approach and solution for collecting connections data irrespective of the underlying connection manager. As shown in FIG. 1, the Universal Connections Data Collection module 100 is an end-to-end solution that may include several components or modules including an event notification module 105/109, a collector module 107 to collect and initially store the data, a correlation module 113 to process and normalize the collected data, and an upload module 117 that uploads the normalized records. As shown, the Universal Connections Data Collection module may be installed on the endpoint and perform the job of collecting, processing (e.g., normalizing), storing and uploading to a central repository 130 the network connections information.

An endpoint, as used herein, means any computing device that is somehow making a connection to the network. Also as used herein, a computing device is a machine that manipulates data according to a set of instructions, including for example, a computer, a wireless handheld device (e.g., cellular telephone, BlackBerry, personal digital assistant (PDA), etc.), and other smart mobile devices. In preferred embodiments, the connection being made is an Internet Protocol (IP) connection. In preferred embodiments, the Universal Connections Data Collection solution is being notified by the Operating System (OS) of an IP connection. The Universal Connections Data Collection module may be located at the endpoint and may be included in, integrated into, and/or added onto a computing device.

In some embodiments, the Universal Connections Data Collection module can be implemented as a standalone module to perform collection and storage, processing, and uploading of IP connection data without any dependencies on other components. In some embodiments, the Universal Connections Data Collection module can be implemented as an add-on module integrated into other connection managers. For example, the add-on module may integrate to other computing device software using an Application Programming Interface (API) to communicate. Examples of other computing device software would be third party connection managers that provide a mechanism to get connected and that collect data related to the IP connections that are made. Other embodiments may include combinations of standalone and add-on connections data collection solutions.

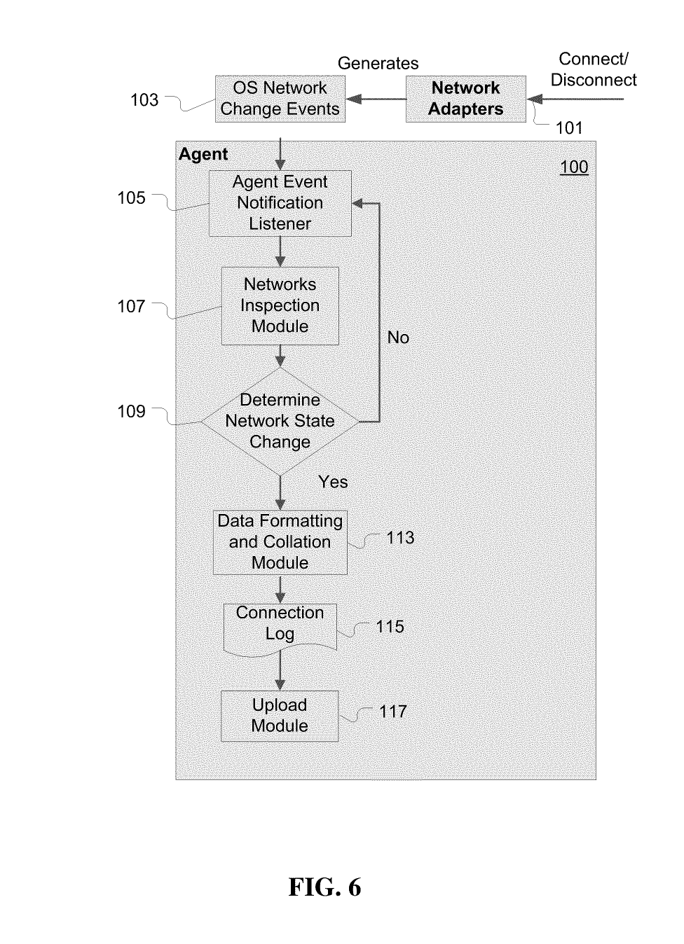

As shown in FIG. 1, the notification module 105/109 includes an Agent Event Notification Listener 105 that may be triggered by network change events. Network change events may be generated, for example, as OS network change event and/or third party connection manager connectivity events. For example, the Universal Connections Data Collection module may sign up for various OS and third party connection manager connectivity event notifications (e.g., 103, 201, 203, 301, 303 in FIGS. 6, 8, and 10). The Universal Connections Data Collection module may receive a wide range of notifications and may compare these notifications against a set of configurable criteria (105, 109). This notification information may be parsed for interesting notifications by looking at the adapter name that the notification was generated for (113). A specific list of known adapters may be part of the Universal Connections Data Collection module and be updated as required. A connection event detected by the Agent Event Notification Listener 105 may be passed to the Networks Inspection Module 107 and an initial parsing of the event notifications may be made to identify events of interest.

The collector module 109/113 shown in FIG. 1 may include Data Formatting and Collation Module 113 and logic of determining a network state change 109. This may be accomplished for a notification of interest via a comparison of connected networks with the last saved connected networks to determine whether the connection event is a new or lost connection. A scan of the adapter and OS attributes may be performed as part of the initial connection collection. The state of the adapter may be noted as active. Connection data collection may continue until a disconnect is noticed. As long as the adapter is active and does not change state, information about the adapter may be continuously collected. When a new notification is received for the same adapter indicating that it has experienced an IP state change or a disconnect, a final connection collection may be performed and a correlation triggered.

The correlation module includes the Data Format and Collation module 113 (FIG. 1) and associate logic to parse the collected connections data and create a collection record with the connections data and any attributes collected. Preferably, the connections data includes, at a minimum, a connection start and connection stop, and optionally other connections data and attributes collected during the lifetime of the active connection. Connections data and attributes, including initial connections data and normalized connections data and records may be stored in a datastore 111.

As shown in FIG. 1, the upload module 117 uploads the collection record(s) and connection logs 115 to a unified reporting solution 130 via a communications network, such as the Internet 120. The connection logs preferably include connections data and attributes collected throughout the lifetime of the connection.

In addition to collecting, normalizing and storing the connections data from one or more computing devices, various views of the collected connections data may be provided that may be useful to help analyze user behavior and computing device connection usage for a group of computing devices.

The Universal Connections Data Collection solution may provide IT administrators visibility into all connections made from their corporate computing devices and helps them answer usage pattern questions (regardless of the software used for connectivity) across various dimensions. Connections data collection and reported may include:
Network types used (e.g., Corporate, Home, VPN, etc.)
Public networks used (e.g., could specify the provider name)
Location from which the connection (e.g., which office, which building, etc., which may be especially useful for Corporate networks)
Connection Security Status (e.g., Secure hotspot, insecure hotspot etc.);
VPN details (e.g., as and when used)
Endpoint Security Posture during connection (e.g., compliant, non-compliant etc.)
Other relevant Endpoint details during connection (e.g., IP address, user name etc.).
   Using IP connections data collection solution, usage pattern questions across various dimensions may be answered regardless of the software used for connectivity.

A breakdown of some exemplary tasks of the IP connection data collection solution is as follow:

According to one task, the Universal Connections Data Collection module may register for network change events with a number of different mechanisms—for example, the OS as well as third party connection managers. Whenever the computing device connects to or disconnects from a network, the collection module receives a call back from the source to react to the change in the machine's connectivity status.

In accordance with another task, the Universal Connections Data Collection module may enumerate all IP connections to determine if a new network has been added or a network connection has been lost. If a new network has been added, it collects details on the network and will start monitoring its statistics. The collection module would be notified, for example, upon Wired Broadband, Wireless, Mobile Data, Dialup and VPN (IPSec, L2TP, other) connectivity.

In accordance with another task, the Universal Connections Data Collection module may collate the network information and export the connection details into a connection log upon loss of network connectivity. The connection log may also include relevant endpoint information (e.g., username, device name, IP address, etc.) that the collections module would have already collected.

In accordance with yet another task, the connection logs may be uploaded periodically to a server or unified reporting solution for processing and unified reporting. For example, the server may use this data to create a Connections Dashboard available to IT administrators and/or to create any relevant alerts/exceptions. The data could also be used as in an alerting framework (e.g., SNMP, Syslog) or be exported to other Enterprise Management Systems (e.g., HP OpenView, Tivoli).

In accordance with yet another task, a collection would be trigged upon an adapter state change notification and or a periodic collection of connected adapters.

The Universal Connections Data Collections module may collect generic IP connectivity data along with connection specific attributes (collectively data specification). Examples of generic data attributes that may be common to all connection types (e.g., IP connections) include, but are not limited to:
OS Username
OS Domain
OS Name and version
Host Name
Transport
Adapter Name
IP Address
Subnet Mask
MAC Address
Connection Speed
Connect Time
Disconnect Time
Bytes Sent
Bytes Received
Logical Network Name: used to group all connections from a network
Device Driver Details

Additionally, examples of transport specific data attributes (i.e., specific to certain connection types) that may be collected include, but are not limited to:

Wireless LAN:
SSID
Authentication Type (Open, WEP, WPA, WPA2)
Encryption Type (TKIP, AES)
Infrastructure/AdHoc Mode
Access Point MAC Address

Mobile Data:
Network Name and ID
Service Type (GPRS, EDGE, etc.)
Roaming Status
Card Number

Dialup:
Number Dialed
Connection Name

VPN:
Application Name
Application Version
VPN Server Address
Tunneling Protocol

The Universal Connections Data Collection module may define XML schema for storing IP connectivity acquired by various mediums of connectivity. Mediums of connectivity may include, but are not limited to: Wired Broadband; Wireless LAN; RAS/Dialup; Mobile Data; IPSec VPN; and the like. The Universal Connections Data Collection solution—in either the standalone embodiment or third-party connection manager add-on embodiment (i.e., with IP connections data collection solution adapters to export connection data)—may export the IP connectivity information in the IP connections data collection solution defined XML schema.

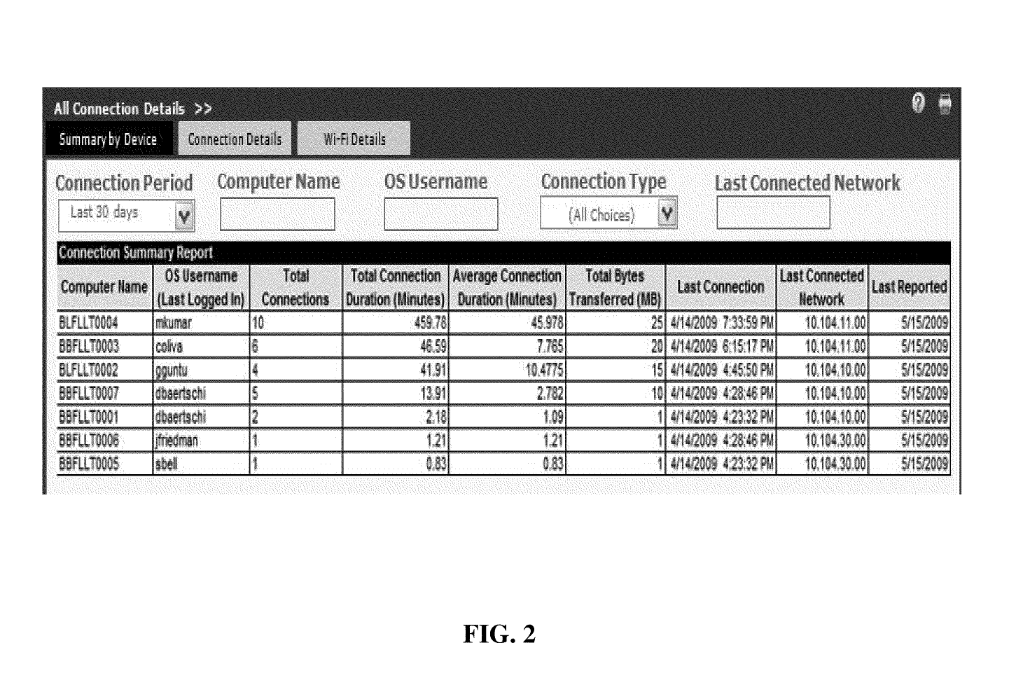

FIGS. 2-4 illustrate several exemplary screenshots of the connection reports that may be generated and output for use in evaluation and assessing user behavior and connectivity efficiencies for a computing device. As shown in the exemplary screenshots that follow, the data specification (described supra) collected by the IP Connections Data Collection solution may be used to generate various connections reports or dashboards.

For example, FIG. 2 shows an exemplary connections report including a summary of connectivity by device. As shown in FIG. 2, the connection summary report may include: the name of the computing device, OS username, total connections, total connection duration, average connection duration, total bytes transferred, last connection, last connected network, and the date last reported.

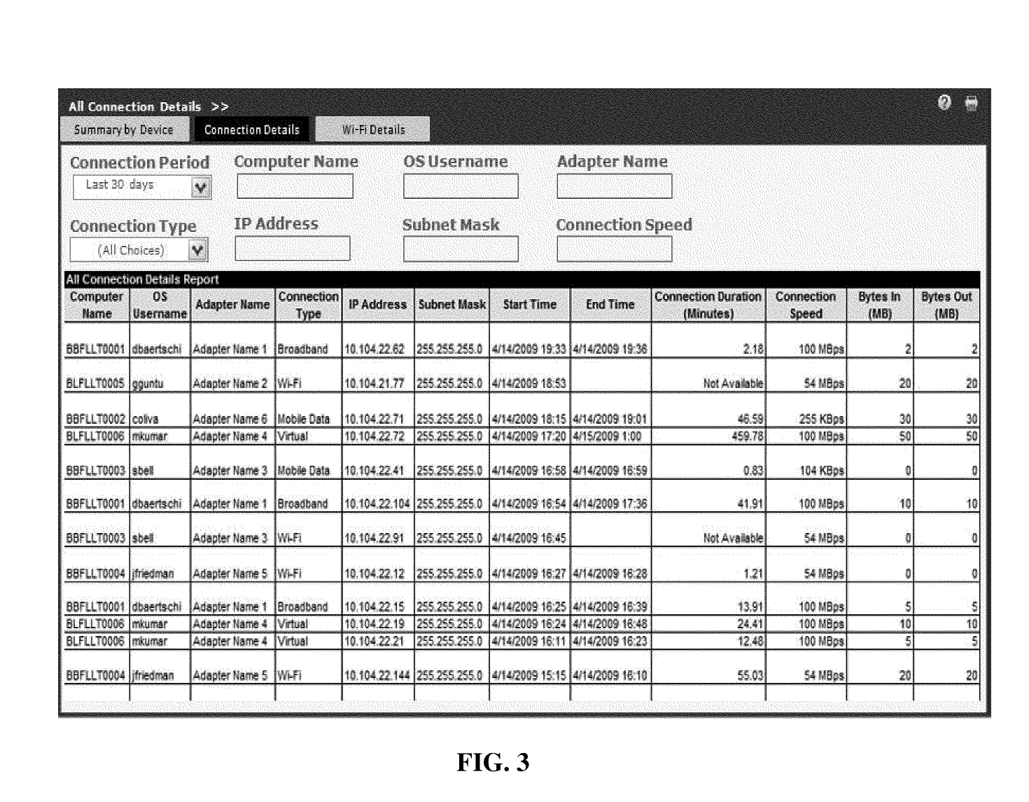

FIG. 3 shows an exemplary connections report including connection details by device. As shown in FIG. 3, the connection details by device report may include: computer name; IS username; adapter name; connection type; IP address; subnet mask; start time; end time; connection duration; connection speed; bytes in; and bytes out.

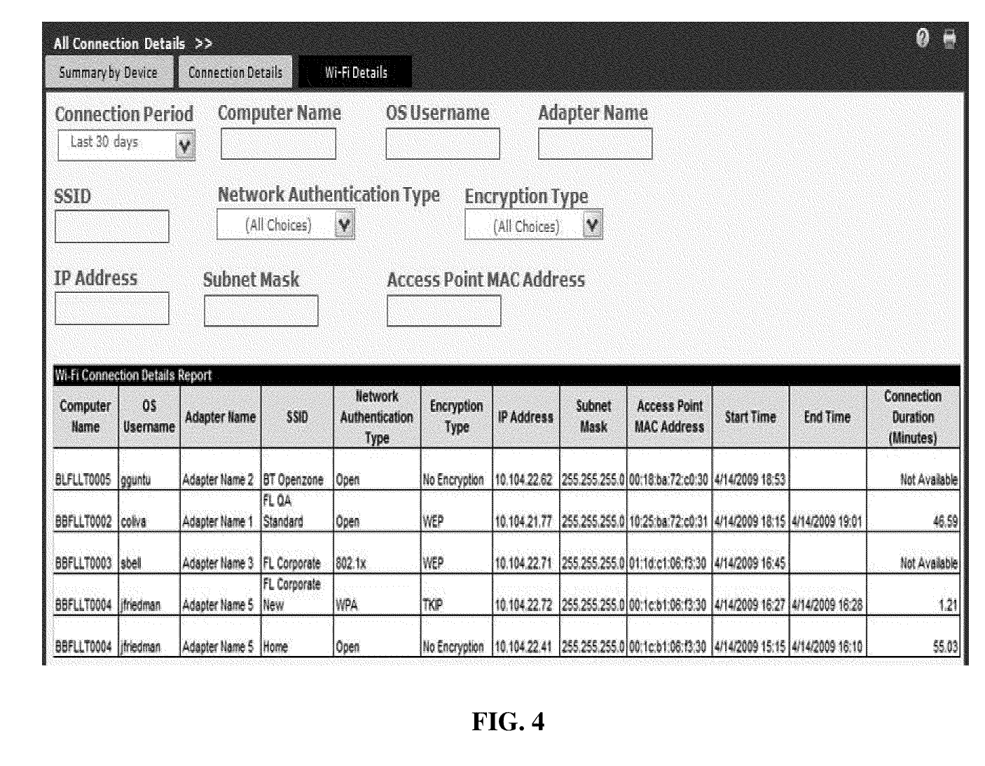

FIG. 4 is a shows an exemplary Wi-Fi connections report including connection details by device. As shown in FIG. 4, the Wi-Fi connections report may include: computer name, OS username, adapter name, SSID, network authentication type, encryption type, IP address, subnet mask, access point MAC address, start time, end time, and connection duration.

The information and data collected and included in the exemplary reports of FIGS. 2-4 may be used in a variety of ways and by various functions in an organization. For example: a finance user may be interested in the top ten usage of expensive transports (e.g., 3G, etc.); a help desk user may be interested in the overall success rate of connections over, for example, WiFi; a Network manager may be interested in a relative view of transport usage (e.g., WiFi versus 3G); a Security Officer may be interested in how many connections are over an insecure WiFi link. Other applications or uses may include to reconcile usage records with telecommunications bills and to dispute charges. These events when viewed with other user data related to the security posture of the computing device, user context (organization, role, etc.), and policies in effect add additional value to an organization.

FIGS. 2-4 are exemplary only and are not meant to be limiting. In addition to the exemplary reports/screen shots shown in FIGS. 2-4 and the data shown in those figures, the Universal Connections Data Collection solution may provide the ability to output all data and attributes collected.

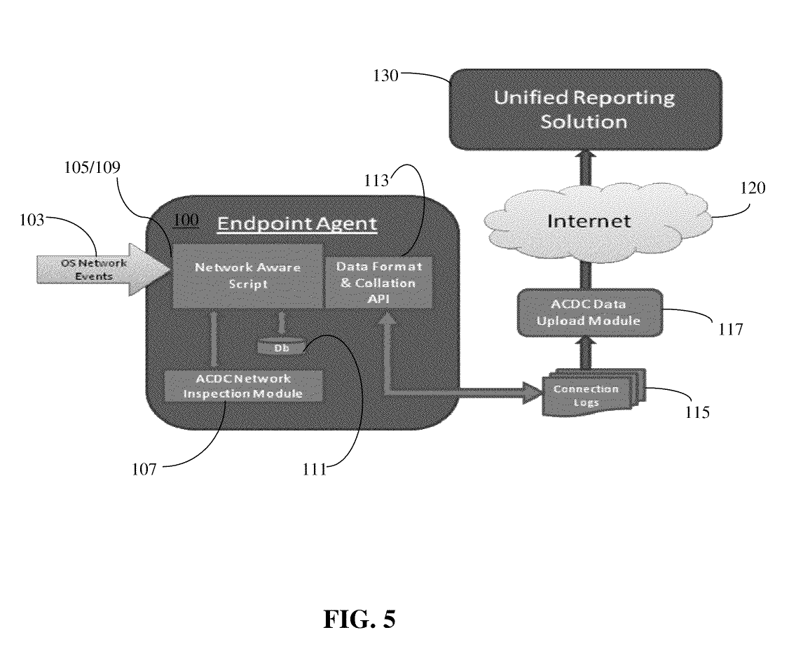

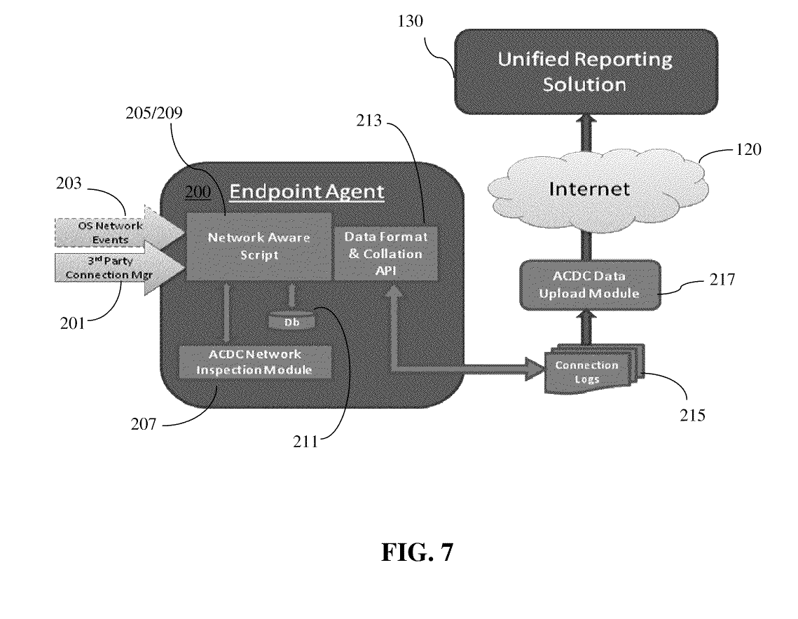

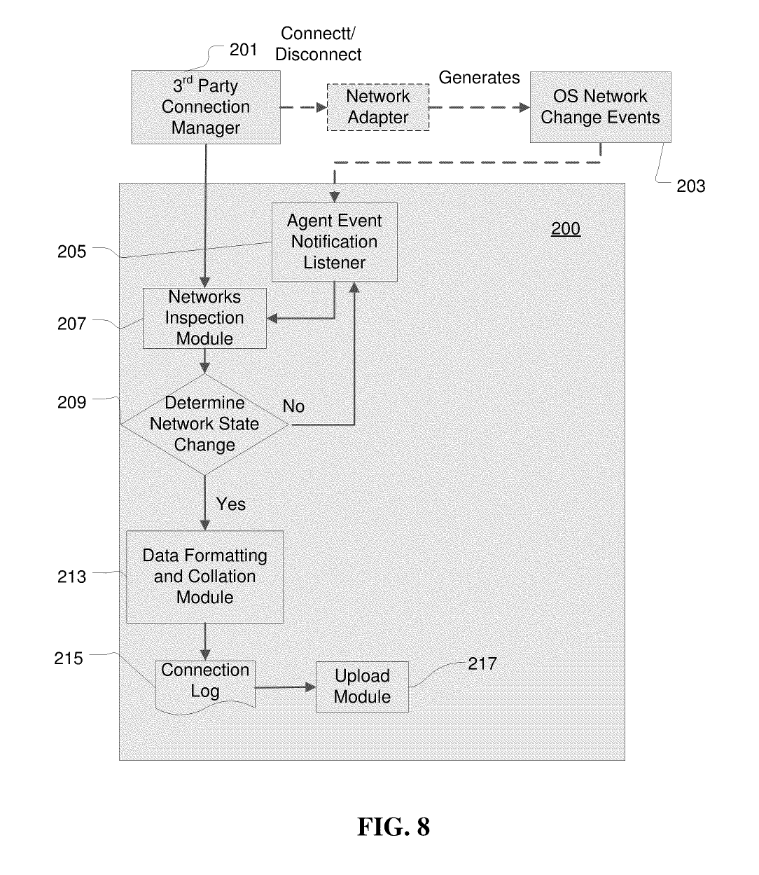

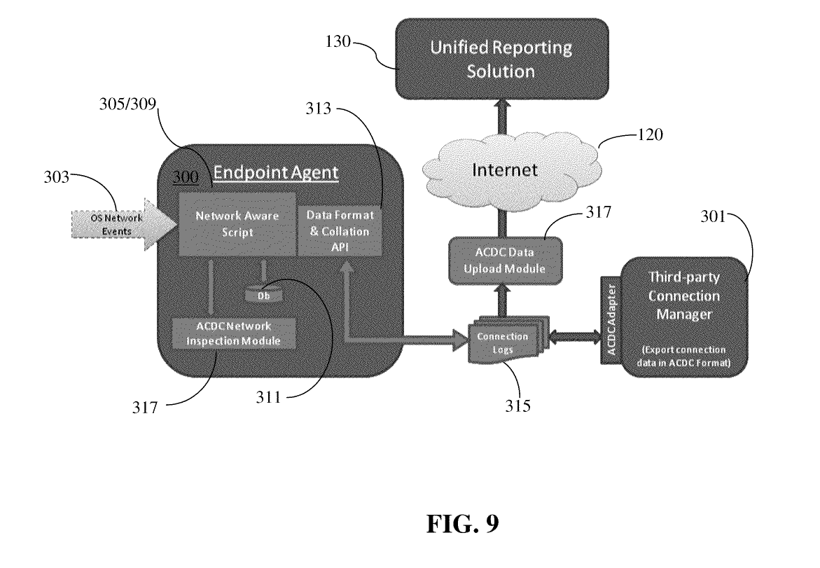

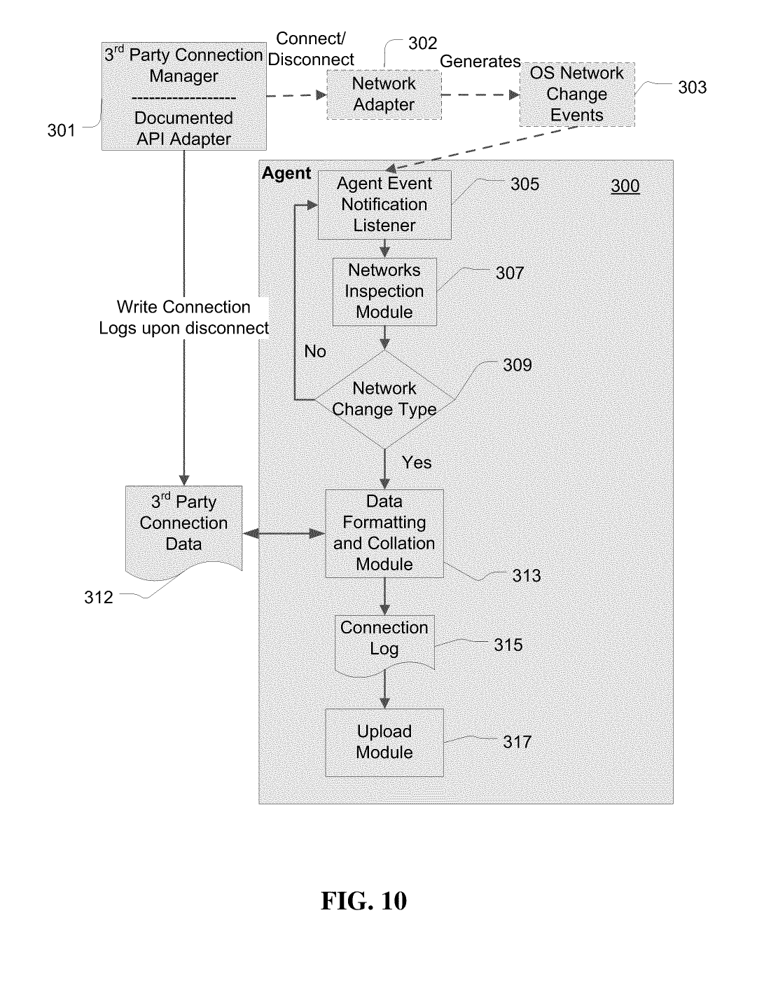

FIGS. 5-10 and the text that accompanies those figures, show and describe embodiments of the Universal Connections Data Collection module/solution in more detail. The IP Connections Data Collection module/solution can function in multiple modes. Exemplary modes include:
a standalone mode: wherein the universal connections data collection module observers the network change event and writes connection logs (see FIGS. 5 and 6);
an API integration with third party connection manager mode: wherein a third party manager calls API exposed by the connection module to pass network details. For example, network name and service used for a mobile data connection. The universal connections data module merges the connection data with its own connection data and writes connection logs (see FIGS. 7 and 8); and
a documented API integration with third party connection manager: wherein a third party connection managers writes connection logs in documented API specification exposed by the connection module. The universal connections data module merges the connection data with its own connection data and writes connection logs (see FIGS. 9 and 10).

FIG. 5 shows a block diagram of an embodiment of the IP connections data collection system functioning in a standalone mode. FIG. 6 is a logic flow diagram showing the process flow for the standalone mode of the IP connections data collection system of FIG. 5.

As shown in FIG. 5, the Universal Connection Data Collection module (100) includes a Network Adapter (101) that may be installed in a computing device or machine. Suitable network adapter include physical (e.g., WiFi and Broadband) and logical/virtual (e.g., VPN) network adapters. Also shown in FIG. 5 is OS Network Change Events (103), which include events that are broadcasted to all listening applications when a network adapter connects or disconnects. In Windows, for example, whenever an adapter is connected or disconnected, a WM_DEVICECHANGE windows message is sent to all open Windows.

The illustrated system includes an Agent Event Notification Listener (105) that may receive events from OS, including network change events. The Agent Event Notification Listener may invoke appropriate event handlers to react to the events. In Windows, for example, the listener receives a WM_DEVICECHANGE message from OS upon a network adapter connect/disconnect event.

Also shown in FIG. 5 is a Network Inspection Module (107). This module evaluates all the active network connections, compares with the result of last evaluation and determines if the machine was connected to a new network or disconnected from a network. The Network Inspection Module may also persist the current state of network connections into persistence store for future comparison. The details of the APIs used to collect network details are described in the following process flow section with reference to FIG. 6. If a network connection is lost, the Network Inspection Module invokes Data Formatting and Collation Module for writing connection logs.

The system includes the ability to Determine Network State Change (109). This decision point is to determine the nature of network change (e.g., new or lost network). This may be accomplished by making a comparison between the current state of network connections with the last known states. A Persistence Store (datastore) (111) may be used to store the last known state of network connections on a machine.

A Data Formatting and Collation Module (113) may create the connection logs for the last disconnected network using the information in the persistence store. A Connection Log (115) may contain connection details (e.g., Data Specification) of, for example, the last disconnected network. This may occur upon notification of a disconnection event.

The process flow may proceed as illustrated in FIG. 6. As shown, when a computing device connects to/disconnects from a network, the network adapters generate connection/disconnect events (101). Operating System (OS) broadcasts the network change events to the subscriber of network change events (103). The Network Event Notification Listener, being a subscriber, receives the network change event (105). The network event notification listener invokes network inspection module to evaluate the nature of network change (107).

The Network Inspection Module inspects the state of networks connections using network APIs (109). The inspection modules may do one or more of the following:
Enumerate all RAS connection using, for example, RAS APIs 1 (RasEnumConnections);
Enumerate all non-RAS network connection using, for example, IP Helper APIs;
Compared the list of active network connection with the last known snapshot of the network state; and/or
Periodically update the statistics of connected network.

Further details of each of above steps that the inspection module may take are described further below. Regarding the enumeration of all RAS connection using RAS APIs (see e.g., http://msdn.microsoft.com/en-us/library/ms764032(VS.85).aspx) (RasEnumConnections), the APIs may be used to gather network information, including but not limited to:
Adapter Name (RasSetEntryProperties API)
Connection Type—VPN/modem/ISDN (RasSetEntryProperties API)
DUN Entry Name (RasSetEntryProperties API)
Phone Number Used (RasSetEntryProperties API)
IP Address (RasGetProjectionInfo API)
Connection Speed (RasGetConnectionStatistics)
Bytes Received (RasGetConnectionStatistics)
Bytes Transferred (RasGetConnectionStatistics)

Regarding the enumeration of all non-RAS network connection using IP Helper APIs (see e.g., http://msdn.microsoft.com/en-us/library/aa366073(VS.85).aspx), the following network information may be gathered:
IP Address
Subnet Mask
Network ID: IP Address masked with Subnet Mask
Connection Speed
MAC Address
Bytes Received
Bytes Transferred
Wi-Fi connection information
Mobile Data connection information

For Wi-Fi connections, additional attributes may be collected using, for example, NDIS APIs:
SSID
Network Authentication Type
Data Encryption
Access Point MAC Address
Infrastructure mode

For Mobile Data connections, the additional attributes may be collected, for example, using Mobile Broadband API (see e.g., http://msdn.microsoft.com/en-us/library/dd323271(VS.85).aspx) (Windows 7 only):
Provider Name
Data Service Type (GPRS, EDGE, UMTS, HSDPA, etc)
Roaming/Non-roaming

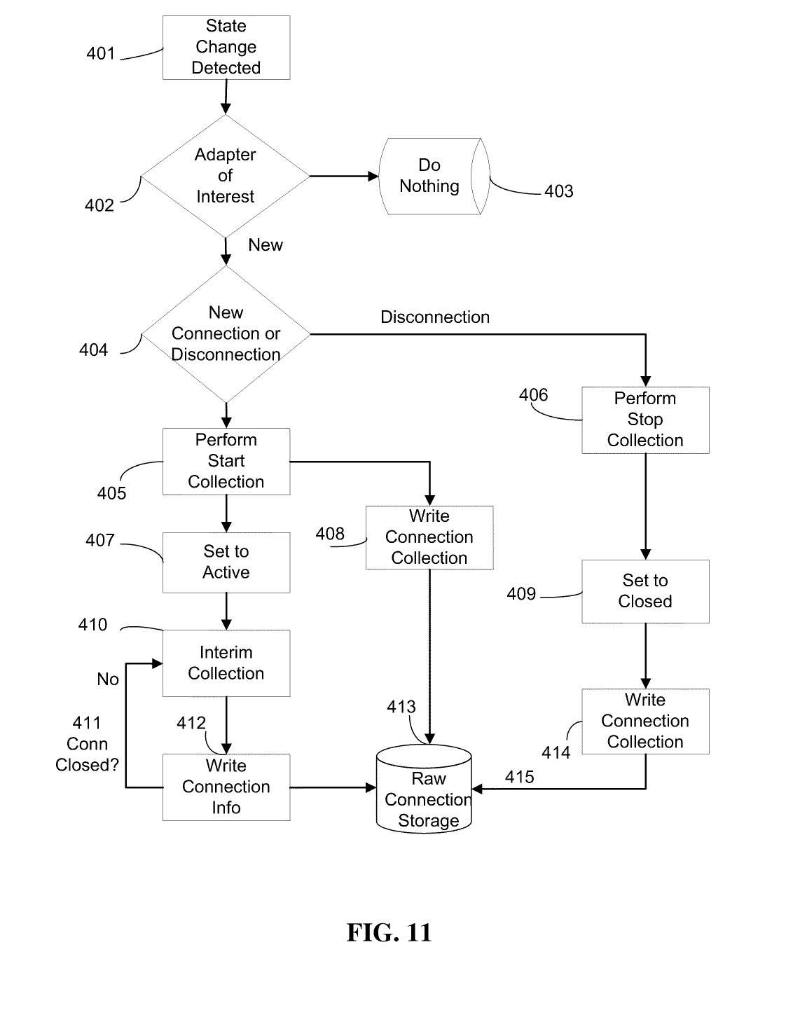

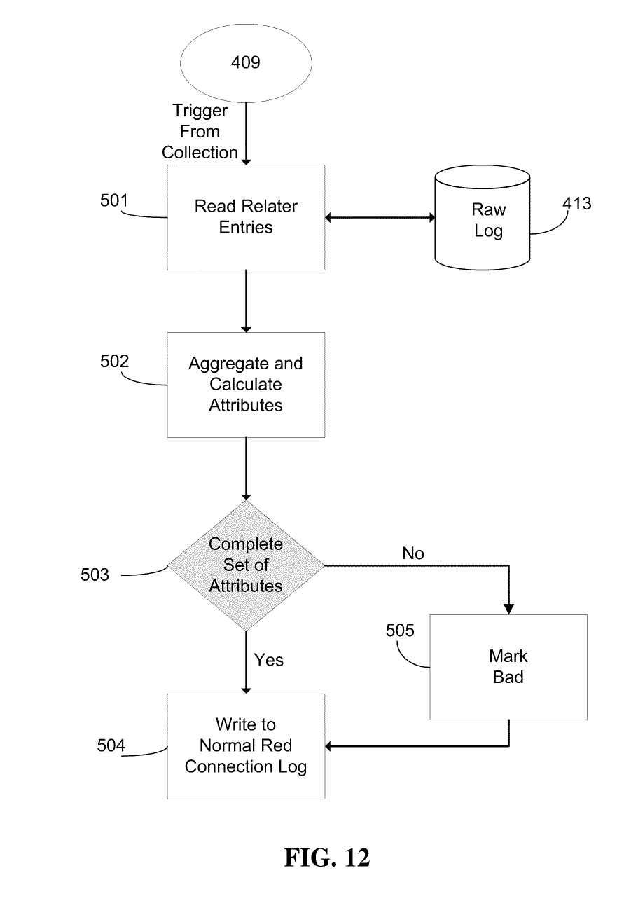

As shown in FIG. 6, the endpoint agent of the IP Connections Data Collection module may determine a network state change. This may be accomplished using the list of active network connection that may be compared with the last known snapshot of the network state (109). If a new network is found in the active connections list, it may be treated as a new connection. The network details may be persisted in the persistence store, along with the start time of the connection (111). If no change in network state is detected at (109), the process may continue to listen for event notification (at 105). If a network present in persistent store is not found in the active connections list, it may be treated as a lost connection. The network's connection stop time may be updated in persistence store. A Data Formatting and Collation Module may be invoked to export the network connection details in the connection log (113). Additional details of the collections logic and correlations logic are shown and described below with reference to FIG. 11 and FIG. 12.

The Networks Inspection Module may periodically update the statistics of connected network(s). For example, statistics may be updated at pre-determined intervals and/or upon the occurrence of an event. Examples of the details that may be updated include:
Bytes Received
Bytes Transferred
Last known connected time (can be used to close active connection in event of unexpected machine crash)

As shown, the Data Formatting and Collation module, when invoked by Network Inspection Module, may iterate through all closed network connections and exports the network connection details in the connection log (113, 115).

Embodiments of the present invention may support collection of a connection within a connection. A computing device can have real and virtual adapters. Virtual adapters are typically used for VPN connections. Some embodiment of the Universal Connections Data Collection solution may include a capability as part of the correlation logic that could analyze a connection made using a virtual adapter and associate it to the real adapter and correlate it to the underlying connection. This may have value in that it would show when VPN connections are being made and as a compliance reporting tool to understand if a policy to use VPN is being followed. As an example, a written policy may state that a VPN must be used on all public networks. This data could support a report on which devices/users are adhering to the policy. Other scenarios include understanding multiple connections and being able to tell when a device has concurrent connections over multiple adapters.

An endpoint computing device or machine may have multiple network connections at the same time. In this situation, the agent would create one connection log for each connection. An exemplary use case would be VPN connections, which are created over a base internet connection (e.g., Broadband, WiFi, Dial, mobile data, etc.). When the endpoint agent receives a network change event for a base connection, the network inspection would reveal a new connection (as the last inspection would not have any connected networks) and it would start monitoring the network connection. After some period of time, when a VPN connection is established, the agent would again receive a network change event. Subsequent network inspection would reveal that a new network had been found (the VPN adapter wasn't present during the last inspection) and hence the VPN connection would start being monitored. When the VPN adapter is later disconnected, the agent will receive a network change event. The endpoint agent will evaluate the network list and determine that there is only one active connection (the base connection) whereas the last inspection showed two network connections. Hence, the endpoint agent would treat the VPN connection as a lost connection and would write the connection details in the connection log. The VPN details including, for example, adapter name, connection start time, connection end time, connection speed, etc. may be written to the connection log. In such a manner, the Universal Connections Data Collection solution may allow for monitoring and reporting of connections within connections.

FIGS. 7 and 8 show another embodiment of the Universal Connections Data Collection solution, wherein the Universal Connections Data Collection module 200 may be integrated with another third party connection manager. FIG. 7 shows an exemplary process flow for the collection module's API integration with a third party connection manager. Some of the functioning of the Universal Connections Data Collector in this mode may be similar to the standalone mode. In this mode, however, apart from extracting the network details using the stated methods in standalone mode, the Network Inspection Module may retrieve additional network connection data and/or attributes from the third party connection manager.

As shown in FIG. 7, a third party connection manager (201) may include a software agent on a machine to facilitate/monitor connection to a network. One example of a third party connection manager is Vodafone's Vodafone Mobile Connect (VMC) mobile data connection manager. The third party connection manager may provide additional network connection data/attributes to the Network Inspection Module 207. These attributes are typically the network attributes that are not exposed by the OS and would only be known to the connection manager initiating the connection. For example, mobile data connection attributes like “Network Name,” “Roaming,” and “Service Type” to name a few.

The Network Adapter (202), OS Network Change Event (203), Agent Event Notification Listener (205), Determine Network State Change (209), Persistence Store (211), Data Formatting and Collation Module (213) and Connection Logs (215) shown in FIGS. 7 and 8 are essentially the same modules/components and perform essentially the same functions as the corresponding components shown and described with respect to FIGS. 5 and 6.

The Network Inspection Module (207) shown in FIGS. 7 and 8 may evaluate all the active network connections, compare with the result of last evaluation and determine whether the machine connected to a new network or disconnected from a network. When a new connection is initiated, The Network Inspection Module may also retrieve additional network attributes from a third party connection manager. The Network Inspection Module may merge the supplied network attributes with the attributes found during its own inspection, and persists the current state of the network connections in persistence store for future comparison. If a network connection is lost, The Data Formatting and Collation Module (213) may be invoked for writing connection logs.

An exemplary process flow for this add-on mode is shown in FIG. 8. As shown, when a mobile data third party connection manager starts a mobile data connection (201), the endpoint agent would receive a network change event from the OS (203). The Network Inspection Module (207) would recognize that a network has been added (209), and add the network details to the persistence store (211). The third party connection manager (201) may also provide additional connection information like Network Provider, Data service type and Roaming for the connected adapter (205), which the Network Inspection Module may retrieve. The Network Inspection Module (207) may update the additional network information in persistence store (211).

FIGS. 9 and 10 show another exemplary add-on embodiment of the Universal Connections Data Collection solution, wherein the Universal Connections Data Collection solution's Documented API may be integrated with a third party connection manager. As shown in FIGS. 9 and 10, some of the components and functioning of Universal Connections Data Collection solution in this mode may be similar to the standalone mode. For example, Network Adapter (302), OS Network Change Events (303), Agent Event Notification Listener (305), Network Inspection Module (307), Determine Network State Change (309), Persistence Store (311), and Connection Log (317) may be essentially the same as shown and described with reference to FIGS. 5 and 6.

As shown in the illustrated embodiment, additional attributes may be exported by the third party connection manager using a documented API specification published by the connection data collector module. The Data Formatting and Collection Module (315) may merge the additional network information into the Persistence Store (311).

As shown in FIG. 10, in this embodiment a Documented API Adapter (301) may integrate a third party connection manager with the Collections Agent. The third party connection manager may include a software agent on a machine to facilitate connection to a network. One such example includes Vodafone's Vodafone Mobile Connect (VMC) mobile data connection manager. As shown, a third party connection manager may export additional network connection attributes (312) using the documented API specification to be picked up by Data Formatting and Collation Module (313).

Third Party Connection Data (312) comprising additional network connection data in a document specification may be exported by a third party connection manager. These attributes may include, for example, the network attributes that are not exposed by the OS and would only be known to the connection manager initiating the connection. For example, mobile data connection attributes like “Network Name,” “Roaming,” and “Service Type.”

The Data Formatting and Collation Module (313) may create the connection logs for the last disconnected network. The Data Formatting and Collation Module may read the network details in Third Party Connection Data (312) and may merge this data with the network details stored in the Persistence Store (311). The collated data may be exported as a connection log (315). Connection logs may be uploaded via Upload Module (317).

Preferably, the Universal Connection Data Collection solution (200, 300) may be used in the add-on mode with any existing third party connection manager. Examples of third part connection managers for which the Universal Connection Data Collection module may be integrated include: Fiberlink Extend360; iPass Connect; Vodafone Mobile Connect; ATT Connect; Verizon Connect; Juniper Odyssey; Microsoft Wireless Zero Config; and various PC vendor built-in solutions, such as employed by Dell, IBM and HP who all have their own proprietary connection managers.

As shown in FIGS. 5, 7, and 9, the Universal Connection Data Collection module may upload connection data and information in the connection logs to a unified reporting solution. For example, the data upload module may perform periodic checks for availability of an active connection (e.g., internet connection) and upload the connection log files to the unified reporting server. The data upload module may also check for pending logs file to be uploaded after detecting a new network connection.

Embodiments of the Universal Connections Data Collection solution address several business needs and may be useful for a variety of purposes. For example, providing IT administrators visibility into all connections made from their corporate devices. The Universal Connections Data Collection solution may provide robust complete collection of connections data in a consistent format and across all connections, which may have particular value to network administrators—especially when integrated with existing third party connection managers. The functionality essentially provides an abstraction between the various third party connection managers collection capabilities, data formats and the reporting interface. The data collected and information reported may help IT administrators answer one or more of the following questions:
Overall user connectivity patterns—including those connections made outside of a third party connections manager
Network types used (e.g., Corporate, Home, etc.)
Roaming networks used
The location where users are connecting (which office, which building, etc., which may be especially useful for Corporate network)
Whether users are connecting to secure hotspots or open ones
   Another example includes improving data quality of specific attributes in existing third party connections manager established connections.

Additional features and attributes that may be incorporated into the Universal Connections Data Collection solution include:
Consolidated reporting module that displays connections established by existing third party connections managers as well as other connection managers on the endpoint device
Data consolidation by correlating existing connections data and connections data collected by the Universal Connections Data Collection solution, and removal of duplicates
Pre-determined Source of Truth for various attributes to ensure data accuracy
For connections made by third party connection manager, the Universal Connections Data Collection solution record may be the source for all attributes
The computing device as a key reporting dimension—e.g., username as an attribute
Backward compatibility with existing versions of third party collections managers

In some embodiments, the collector module may be used to collect all remote access server (RAS) and network device interface standard (NDIS) connections made on the endpoint. RAS may include, for example, Dial and some other types of Mobile Data and VPN connections. NDIS may include, for example, Ethernet, Wi-Fi and some types of Mobile Data and VPN connections. In some embodiments, the collector module may be designed to capture as much connection type specific attributes as possible. Some embodiments may structure the captured connectivity information in a format similar to user experience (UE) logs to facilitate ease in assessing the collected data and connectivity information. Some embodiments may include the ability to distinguish Universal Connections Data Collection connectivity records from other logs uploaded. Some embodiments may include the ability to selectively turn-on the Universal Connections Data Collection solution only for some customers so that needless data does not get uploaded to the reporting portal. The Universal Connections Data Collection solution provides the generated connectivity records to the upload module for upload/reporting. In some embodiments, connectivity logs processed and generated by the Universal Connections Data Collection solution may be stored and/or reported separately from processed third party manager records. Some embodiments may include a data retention and archival policy for connections data and attributes collected by the Universal Connections Data Collection solution and/or generated in connection logs.

Embodiments of the present invention preferably provide for the monitoring and collection of IP connections data on a continuous basis and in real time. The OS notifies the Universal Connections Data Collection solution of a connection, disconnection, and/or change in state of an IP connection. Continuous monitoring and event driven OS notification allows the Universal Connections Data Collection solution to collect connections data without visibility of when someone hits a connect button.

FIG. 11 is a flow chart showing an exemplary collections logic flow that may be implemented in the various embodiments of the Universal Connections Data Collection solution. As shown in FIG. 11, the collections logic may received an event notification of a state change detection (401) from, for example, (109), (209), (309). The adapter that the notification is related to may be checked against a list of adapters on interest (402). If it is an adapter of interest the process continues to (404). If not, no action is taken (403) and the process ends.

At step (404), the notification information may be parsed to determine, for example, if the event is for a new connection or the end of an existing connection. If a new connection is noticed, the connections logic follows the new connection process (to 405). If a disconnection, the connections logic follows the connection ending process (to 406).

Following the new connection path, a collection of the target adapter attributes for the new connection event may be performed (405). At (407), the process may flag the adapter as active. Also, the process may write the collected data to the raw connection data store (408). Raw adapter attribute collection data may be stored (413).

After the new connection adapter has been flagged (at 407), a periodic interim collection of target attributes may be performed for the active connection and adapter (410). The interim collection may continue (411) as long as the active flag is set (407). The logic may write the collected data to the raw connection data store (412). Storage for raw adapter attribute collection data is shown at (413).

Following the disconnection path, a collection of the target adapter attributes for the end of the connection event may be performed (406). The adapter may be flagged as inactive, connection ended (409). The logic may write the collected data to the raw connection data store (414). Storage for raw adapter attribute collection data is shown at (413).

FIG. 12 is a flow chart showing an exemplary correlations logic flow that may be implemented in the various embodiments of the Universal Connections Data Collection solution. As shown in FIG. 12, the correlation logic may include a trigger from the collections logic, for example, from step 409 of FIG. 11. In accordance with the illustrated correlations logic, when a connection has ended, the correlation process may be triggered (409) and all raw attributes for the connection may be read (501) from the raw attribute data store (413). At (501), the correlation logic may read related entries.

All the attributes collected may be aggregated and/or calculated to determine final values (502). A test or review may be performed to determine if attributes required to represent a complete collection record have been completed (503). If all the required attributes can be represented, the connections data and attributes may be written to the connections log (115) (at step 504). If the required set of attributes have not been collected and cannot be supplied, the record may be flagged as incomplete and then written to the normalized collection log (115) (at step 505).

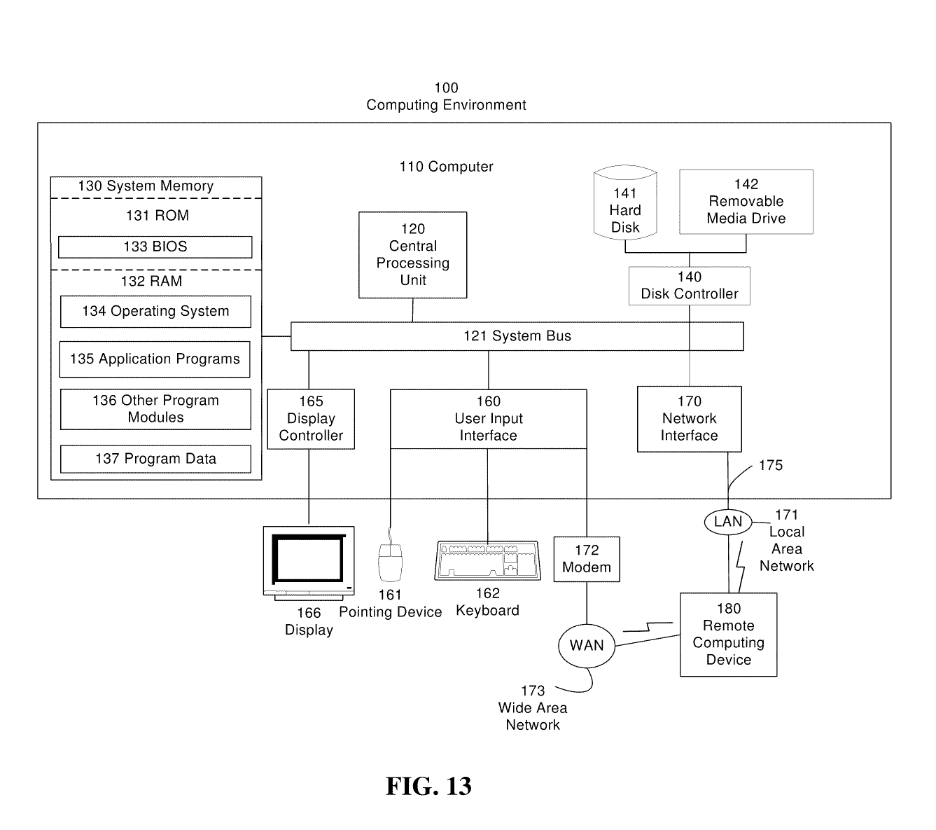

FIG. 13 illustrates an exemplary computing environment 100 within which embodiments of the invention may be implemented. Computing environment 100 may include computer system 110. Computer system 110 is one example of a general purpose computing system upon which embodiments of the invention may be implemented. Computers and computing environments, such as computer 110 and computing environment 100 are known to those of skill in the art and thus are described briefly here.

As shown in FIG. 13, the computer system 110 includes a bus 121 or other communication mechanism for communicating information, and a processor 120 coupled with the bus 121 for processing the information. The computer system 101 also includes a system memory 130 coupled to the bus 121 for storing information and instructions to be executed by processor 120.

The system memory 130 may include computer storage media in the form of volatile and/or nonvolatile memory such as read only memory (ROM) 131 and/or random access memory (RAM) 132. The system memory RAM 132 may include other dynamic storage device(s) (e.g., dynamic RAM (DRAM), static RAM (SRAM), and synchronous DRAM (SDRAM). The system memory ROM 131 may include other static storage device(s) (e.g., programmable ROM (PROM), erasable PROM (EPROM), and electrically erasable PROM (EEPROM). In addition, the main memory 130 may be used for storing temporary variables or other intermediate information during the execution of instructions by the processor 120.

A basic input/output system 133 (BIOS) containing the basic routines that help to transfer information between elements within computer 110, such as during start-up, may be stored in ROM 131. RAM 132 may contains data and/or program modules that are immediately accessible to and/or presently being operated on by central processing unit 120. System memory 130 additionally may include, for example, operating system 134, application programs 135, other program modules 136 and program data 137.

The computer system 110 also includes a disk controller 140 coupled to the bus 121 to control one or more storage devices for storing information and instructions, such as a magnetic hard disk 141, a removable media drive 142 (e.g., floppy disk drive, read-only compact disc drive, read/write compact disc drive, compact disc jukebox, tape drive, and removable magneto-optical drive). The storage devices may be added to the computer system 110 using an appropriate device interface (e.g., a small computer system interface (SCSI), integrated device electronics (IDE), enhanced-IDE (E-IDE), direct memory access (DMA), or ultra-DMA.

The computer system 110 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 110 may also include a display controller 165 coupled to the bus 121 to control a display or monitor 165, such as a cathode ray tube (CRT) or liquid crystal display (LCD), for displaying information to a computer user. The computer system includes an input interface 160 and one or more input devices, such as a keyboard 161 and a pointing device 162, for interacting with a computer user and providing information to the processor 120. The pointing device 162, for example, may be a mouse, a trackball, or a pointing stick for communicating direction information and command selections to the processor 120 and for controlling cursor movement on the display 166. In addition, a printer may provide printed listings of data stored and/or generated by the computer system 110.

The computer system 110 may perform a portion or all of the processing steps of embodiments of the invention in response to the processor 120 executing one or more sequences of one or more instructions contained in a memory, such as the system memory 130. Such instructions may be read into the system memory 130 from another computer readable medium, such as a hard disk 141 or a removable media drive 142. The hard disk 141 may contain one or more datastores and data files used by embodiments of the Universal Connections Data Collection solution. Datastore contents and data files may be encrypted to improve security. One or more processors in a multi-processing arrangement may also be employed to execute the one or more sequences of instructions contained in system memory 130. In alternative embodiments, hard-wired circuitry may be used in place of or in combination with software instructions. Thus, embodiments are not limited to any specific combination of hardware circuitry and software.

As stated above, the computer system 110 may include at least one computer readable medium or memory for holding instructions programmed according embodiments of the invention and for containing data structures, tables, records, or other data described herein. Non-limiting examples of computer readable media include hard disks, floppy disks, tape, magneto-optical disks, PROMs (EPROM, EEPROM, flash EPROM), DRAM SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read instructions.

Stored on any one or on a combination of computer readable media, embodiments of the present invention include software for controlling the computer system 110, for driving a device or devices for implementing the invention, and for enabling the computer system 110 to interact with a human user. Such software may include, but is not limited to, device drivers, operating systems, development tools, and applications software. Such computer readable media further comprises a computer program product for performing all or a portion (if processing is distributed) of the processing performed in implementing embodiments of the invention.

Components of the computer system 110 which interpret one or more sequences of instructions may be any interpretable or executable code component including, but not limited to, scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 120 for execution. A computer readable medium may take many forms including, but not limited to, non-volatile media, volatile media, and transmission media. Non-limiting examples of non-volatile media include optical, magnetic disks, and magneto-optical disks, such as hard disk 141 or removable media drive 142. Non-limiting examples of volatile media include dynamic memory, such as system memory 130. Non-limiting examples of transmission media include coaxial cables, copper wire, and fiber optics, including the wires that make up the bus 121. Transmission media may also take the form of acoustic or light waves, such as those generated during radio wave and infrared data communications.

Various forms of computer readable media may be involved in carrying out one or more sequences of one or more instructions to processor 120 for execution. For example, the instructions may initially be carried on a magnetic disk of a remote computer. The remote computer may load the instructions for implementing all or a portion of the present invention remotely into dynamic memory and send the instructions over a telephone line using a modem. A modem local to the computer system 110 may receive the data on the telephone line and use an infrared transmitter to convert the data to an infrared signal. An infrared detector coupled to the bus 121 may receive the data carried in the infrared signal and place the data on the bus 121. The bus 121 carries the data to the system memory 130, from which the processor 120 may retrieve and execute the instructions. The instructions received by the system memory 130 may optionally be stored on storage device 141 or 142 either before or after execution by processor 120.

The computing environment 100 may further include the computer system 120 operating in a networked environment using logical connections to one or more remote computers, such as remote computer 180. Remote computer 180 may be a personal computer, a server, a router, a network PC, a peer device or other common network node, and typically includes many or all of the elements described above relative to computer 110. The logical connections depicted in FIG. 13 include local area network (LAN) 171 and wide area network (WAN) 173, but may also include other networks. Such networking environments may be common in offices, enterprise-wide computer networks, intranets, and the Internet. Communications may occur via hard wired and/or wireless means.

When used in a LAN networking environment, computer 110 may be connected to LAN 171 through network interface 170. When used in a WAN 173 networking environment, computer 110 may include modem 172 for establishing communications over WAN 173, such as the Internet. Modem 172 may be connected to system bus 121 via user input interface 160, or other appropriate mechanism.

As shown, the computer system 110 may include a communication interface 175 coupled to the bus 121. The communication interface 175 provides a two-way data communication coupling to a network link 171, 173 that is connected to, for example, a local area network (LAN) 171, or to another communications network 173, such as the Internet. For example, the communication interface 175 may be a network interface card to attach to any packet switched LAN. As another example, the communication interface 175 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 175 sends and receives electrical, electromagnetic, or optical signals that carry digital data streams representing various types of information.

Computer 110 or other client device can be deployed as part of a computer network. In this regard, various embodiments pertain to any computer system having any number of memory or storage units, and any number of applications and processes occurring across any number of storage units or volumes. An embodiment may apply to an environment with server computers and client computers deployed in a network environment, having remote or local storage. An embodiment may also apply to a standalone computing device, having programming language functionality, interpretation and execution capabilities.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed:

1. A method for collection and reporting of connections data on an endpoint comprising:
detecting a notification of a network change event at the endpoint;
evaluating the nature of the network change event;
collecting information about a current state of one or more active network connections of the endpoint;
storing, upon a network state change, the current state of the one or more active network connections in a data store;
formatting information about a plurality of states of network connections to create a connection log containing normalized connection data; and
uploading the connection log to a server for further evaluation.

2. The method of claim 1, wherein the step of collecting information about the current state of one or more active network connections of the endpoint occurs continuously after a connection has been established.

3. The method of claim 1, wherein the step of formatting comprises parsing and collating information about the plurality of states of network connections in accordance with a predefined schema.

4. The method of claim 1, wherein the step of collecting comprises gathering connection attributes from at least one third-party connection manager on the endpoint via an application programming interface (API).

5. The method of claim 1, wherein the information collected includes transport specific data attributes that are determined by the type of network connections.

6. The method of claim 1 further comprising:
monitoring a VPN connection made with a virtual network adapter; and
wherein the information about the state of the VPN connection is included in the normalized connection data in the connection log.

7. The method of claim 6 further comprising:
associating the VPN connection with another network connection and including the information about the association in the connection log.

8. The method of claim 1, wherein the step of collecting comprises gathering network attributes from an operating system on the endpoint.

9. A system for collection and reporting of connections data on an endpoint comprising:
an event notification module configured to detect a notification of a network change event at the endpoint;
a network inspection module configured to collect information about a current state of one or more active network connections of the endpoint;
a data store including a plurality of network states;
a correlation module configured to compare the current state of the one or more active network connections to a corresponding state stored in the data store to determine a network state change, wherein the software system updates the plurality of network states in the data store upon a network state change;
a data formatting and collation module configured to format information about a plurality of states of network connections to create a connection log containing normalized connection data; and
an upload module configured to upload the connection log to a server for further evaluation;
wherein the normalized connection data includes information gathered from an operating system of the endpoint.

10. The system of claim 9, wherein the normalized connection data includes information includes connection data that is gathered continuously after a connection has been established.

11. The system of claim 9, wherein the data formatting and collation module is further configured to parse and collate information about the plurality of states of network connections in accordance with a predefined schema.

12. The system of claim 9, further comprising
at least one third-party connection manager on the endpoint; and
at least one application programming interface (API) configured to allow the system to collect a first set of connection attributes from the at least one third-party connection manager.

13. The system of claim 9, wherein the information collected includes transport specific data attributes that are determined by the type of network connections.

14. The system of claim 9, wherein
at least one software module is configured to monitor a VPN connection made with a virtual network adapter; and
wherein the information about the state of the VPN connection is included in the normalized connection data in the connection log.

15. The system of claim 14, wherein the correlation module is further configured to associate the VPN connection with another network connection such that the association is included in the connection log.

16. The system of claim 9, wherein the step of collecting comprises gathering network attributes from an operating system on the endpoint.

17. A method for collection and reporting of connections data on an endpoint comprising:
receiving a notification of a network change event at the endpoint;
collecting, in response to receiving the notification, information about a current state of one or more active network connections of the endpoint;
storing the current state of the one or more active network connections in a data store;
formatting information about a plurality of states of network connections to create a connection log containing normalized connection data; and
uploading the connection log to a server for further evaluation;
wherein the step of collecting comprises gathering connection attributes via an application programming interface (API).

18. The method of claim 17, wherein the step of collecting further comprises receiving network attributes that are exported by at least one third-party connection manager via the API.

19. The method of claim 17, further comprising the step of merging the connection log with network connection information of a similar format made available by at least one third-party connection manager.

20. The method of claim 17 wherein the step of collecting further comprises gathering network attributes from an operating system on the endpoint.

21. The method of claim 17, wherein the information collected includes transport specific data attributes that are determined by the type of network connections.

22. The method of claim 17 further comprising:
monitoring a VPN connection made with a virtual network adapter; and
wherein the information about the state of the VPN connection is included in the normalized connection data in the connection log.

23. The method of claim 22 further comprising:
associating the VPN connection with another network connection and including the information about the association in the connection log.
